(19) United States
(12) Patent Application Publication
(10) Pub. No.: US 2008/0280585 A1
(43) Pub. Date: Nov. 13, 2008

(54) RF receiver front-end and applications thereof

(75) Inventors: Xinyu Chen, Irvine, CA (US); Hooman Darabi, Irvine, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/801,555

(22) Filed: May 10, 2007

(51) Int. Cl. H04B 1/16

(52) U.S. Cl. 455/338; 455/341

(57) ABSTRACT

A radio frequency (RF) receiver front-end includes an low noise amplifier (LNA) module, a current domain mixing module, and a buffer module. The LNA module is coupled to amplify an inbound RF signal to produce an amplified inbound RF current signal. The current domain mixing module is coupled to mix the amplified inbound RF current signal with a local oscillation to produce a mixed current signal. The buffer module is coupled to provide a baseband or near baseband voltage signal from the mixed current signal.

### CROSS REFERENCE TO RELATED PATENTS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to communication systems and more particularly to radio frequency (RF) receivers.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As wireless communication standard evolve, they are placing more stringent requirements on the linearity, power consumption, and noise generation and/or propagation of the receiver. These more stringent requirements primarily affect the low noise amplifier and the one or more IF stages of the receiver. One embodiment of a receiver front-end (e.g., the low noise amplifier, the one or more IF stages, and any intervening gain and/or filtering stages) includes a single ended low noise amplifier (LNA) stage followed by a transconductance stage, a mixer, a notch filter, an automatic gain control (AGC) stage and low pass filter. The single-end LNA amplifies a received RF signal to produce an amplified RF signal. The transconductance stage converts the amplified RF signal from the voltage domain to the current domain. The mixer mixes the current amplified RF signal with a local oscillation to produce a direct down-conversion signal. The notch filter filters the direct down-conversion signal to provide partial channel selection filtering, which relaxes the linearity requirement of the baseband stages. The AGC stage amplifies the notch filtered direct down-conversion signal to produce a filtered direct down-conversion signal, which is further filtered by the low pass filter.

While such a receiver front-end provides adequate linearity for some wireless communication standards, for more stringent standards (e.g., 3G UMTS third generation Universal Mobile Telecommunications System), which requires an out-of-band IIP3 (Third Order Input Intercept Point) linearity of greater than zero dBm for even the highest gain mode, it cannot provide the required linearity. In particular, the transconductance stage cannot support the high linearity requirements.

Another receiver front-end embodiment includes a variable gain LNA, a direct down-conversion I/Q mixer, an off-chip low pass filter, and a programmable gain amplifier (PGA). The variable gain LNA amplifies, in accordance with a gain setting, a received RF signal to produce an amplified RF signal. The direct down-conversion I/Q mixer converts the amplified RF signal into a baseband signal in accordance with an I/Q local oscillation. The off-chip low pass filter (LPF), which is implemented as a fifth-order active-RF filter having an 8 MHz bandwidth, selects the desired channel. The PGA, which has a gain range of 45 dB in 3-dB steps, amplifies the selected channel to produce an I/Q baseband signal. Note that the filter frequency characteristic is controlled by the RC calibration circuit against temperature and process variation.

In comparison with the preceding embodiment, this embodiment provides improved linearity but the off-chip components of the LPF increases its costs. Further, the off-chip components degrade the noise figure performance of the receiver. Due to noise degradation, this embodiment fails the more stringent requirements of newer wireless communication standards. Further, an increase in cost is rarely an acceptable design alternative.

Therefore, a need exists for a highly linear, low noise, low cost receiver front end.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a wireless communication system in accordance with the present invention;

FIG. 2 is a schematic block diagram of an embodiment of a wireless communication device in accordance with the present invention;

FIG. 3 is a schematic block diagram of an embodiment of a receiver front-end in accordance with the present invention;

FIG. 4 is a schematic block diagram of another embodiment of a receiver front-end in accordance with the present invention; and

FIG. 5 is a schematic block diagram of an embodiment of a common gate buffer in accordance with the present invention.

### DETAILED DESCRIPTION OF THE INVENTION

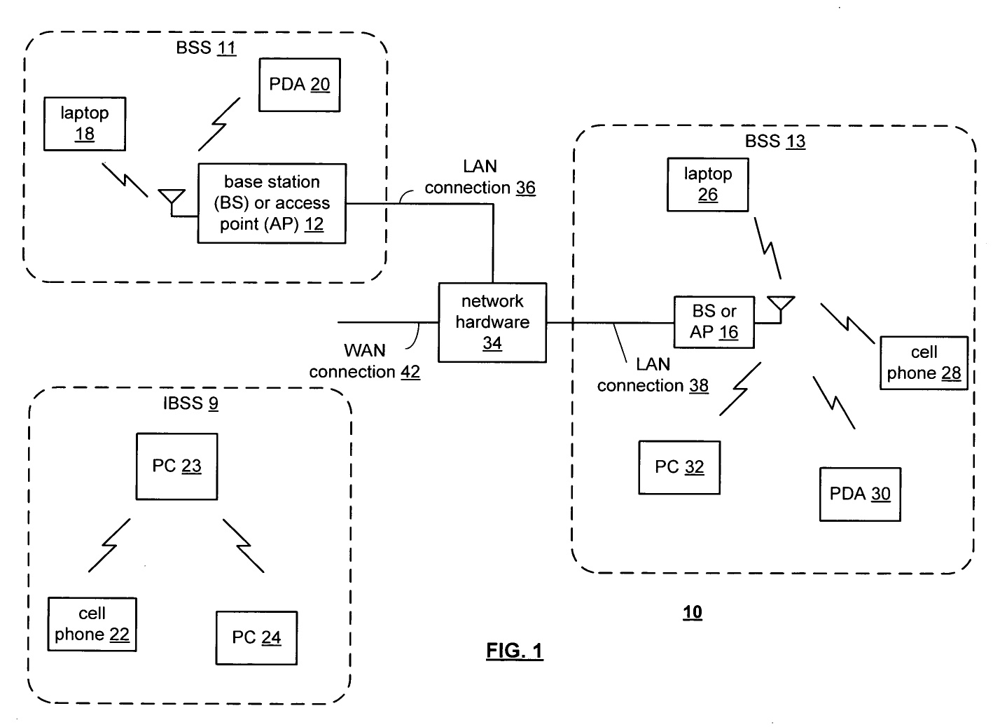

FIG. 1 is a schematic block diagram illustrating a communication system 10 that includes a plurality of base stations and/or access points 12, 16, a plurality of wireless communication devices 18-32 and a network hardware component 34. Note that the network hardware 34, which may be a router, switch, bridge, modem, system controller, et cetera provides a wide area network connection 42 for the communication system 10. Further note that the wireless communication devices 18-32 may be laptop host computers 18 and 26, personal digital assistant hosts 20 and 30, personal computer hosts 24 and 32 and/or cellular telephone hosts 22 and 28 that include a wireless RF transceiver.

Wireless communication devices 22, 23, and 24 are located within an independent basic service set (IBSS) area and communicate directly (i.e., point to point). In this configuration, these devices 22, 23, and 24 may only communicate with each other. To communicate with other wireless communication devices within the system 10 or to communicate outside of the system 10, the devices 22, 23, and/or 24 need to affiliate with one of the base stations or access points 12 or 16.

The base stations or access points 12, 16 are located within basic service set (BSS) areas 11 and 13, respectively, and are operably coupled to the network hardware 34 via local area network connections 36, 38. Such a connection provides the base station or access point 12 16 with connectivity to other devices within the system 10 and provides connectivity to other networks via the WAN connection 42. To communicate with the wireless communication devices within its BSS 11 or 13, each of the base stations or access points 12-16 has an associated antenna or antenna array. For instance, base station or access point 12 wirelessly communicates with wireless communication devices 18 and 20 while base station or access point 16 wirelessly communicates with wireless communication devices 26-32. Typically, the wireless communication devices register with a particular base station or access point 12, 16 to receive services from the communication system 10.

Typically, base stations are used for cellular telephone systems and like-type systems, while access points are used for in-home or in-building wireless networks (e.g., IEEE 802.11 and versions thereof, Bluetooth, RFID, and/or any other type of radio frequency based network protocol). Regardless of the particular type of communication system, each wireless communication device includes a built-in RF transceiver and/or is coupled to an RF transceiver. Note that one or more of the wireless communication devices may include an RFID reader and/or an RFID tag.

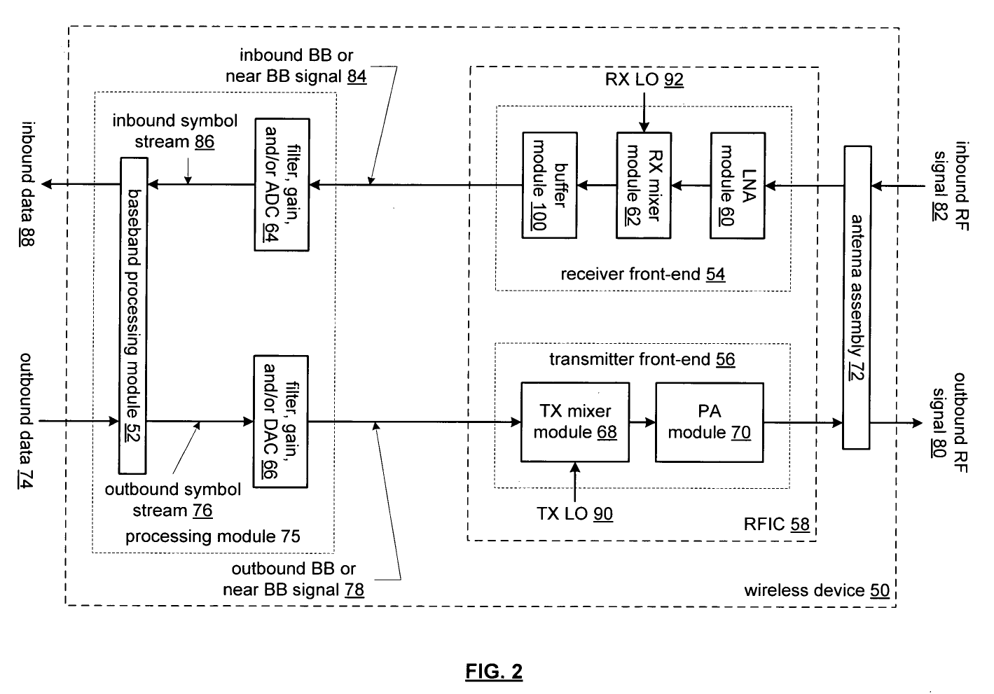

FIG. 2 is a schematic block diagram of an embodiment of a wireless communication device 50 that includes a processing module 75, a radio frequency integrated circuit (RFIC) 58, and an antenna assembly 72. The processing module 75 may include a baseband processing module 52, a filter, gain, and/or analog to digital conversion (ADC) module 64, and a filter, gain, and/or digital to analog conversion (DAC) module 66. The RFIC 58 may be an IC that includes a receiver front-end 54 and a transmitter front-end 56. The receiver front-end 54 may include at least one of a low noise amplifier (LNA) module 60, a receiver mixer module 62, and a buffer module 100. The transmitter front-end 56 may include a transmit mixer module 68 and a power amplifier (PA) module 70. Note that in an embodiment, the receiver front-end 54 may be on a separate IC than the transmitter front-end 56. Further note that in another embodiment, a single IC may support the processing module 75 and the RFIC 58 or the processing module 75 and the RFIC 58 may be on separate ICs. Yet further note that the ICs may be CMOS ICs, biCMOS ICs and/or fabricated from some other type of IC material. Still further note that the wireless communication device 50 may be one of the wireless communication devices 18-32 of FIG. 1 and/or another type of wireless communication device.

The processing module 75 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIG. 2.

In operation, the baseband processing module 52 converts outbound data 74, which may be voice, audio, text, video, images, graphics, etc., into an outbound symbol stream 76 in accordance with one or more wireless communication protocol such as RFID, IEEE 802.11, Bluetooth, AMPS, digital AMPS, GSM, CDMA, wide bandwidth CDMA (WCMDA), LMDS, MMDS, high-speed downlink packet access (HSDPA), high-speed uplink packet access (HSUPA), Enhanced Data rates for GSM Evolution (EDGE), General Packet Radio Service (GPRS), and/or variations thereof. The filter, gain, and/or DAC 66 filters and/or amplifies the outbound symbol stream 76 prior to conversion to analog signal, which corresponds to the outbound baseband (BB) or near baseband signal 78 (e.g., has a carrier frequency in the range of 0 Hz to a few MHz).

The transmit (TX) mixer module 68 mixes the outbound baseband or near baseband signal 78 with a transmit local oscillation 90 to produce an up-converted signal. This may be done in a variety of ways. In an embodiment, in-phase and quadrature components of the outbound baseband or near baseband signal 78 are mixed with in-phase and quadrature components of the transmit local oscillation to produce the up-converted signal. In another embodiment, the outbound baseband or near baseband signal 78 provides phase information (e.g., ±Δθ [phase shift] and/or θ(t) [phase modulation]) that adjusts the phase of the transmit local oscillation to produce a phase adjusted up-converted signal. In this embodiment, the phase adjusted up-converted signal provides the up-converted signal. In another embodiment, the outbound baseband or near baseband signal 78 further includes amplitude information (e.g., A(t) [amplitude modulation]), which is used to adjust the amplitude of the phase adjusted up converted signal to produce the up-converted signal. In yet another embodiment, the outbound baseband or near baseband signal 78 provides frequency information (e.g., ±Δf [frequency shift] and/or f(t) [frequency modulation]) that adjusts the frequency of the transmit local oscillation to produce a frequency adjusted up-converted signal. In this embodiment, the frequency adjusted up-converted signal provides the up-converted signal. In another embodiment, the outbound baseband or near baseband signal 78 further includes amplitude information, which is used to adjust the amplitude of the frequency adjusted up-converted signal to produce the up-converted signal. In a further embodiment, the outbound baseband or near baseband signal 78 provides amplitude information (e.g., ±ΔA [amplitude shift] and/or A(t) [amplitude modulation) that adjusts the amplitude of the transmit local oscillation to produce the up-converted signal.

The power amplifier (PA) module 70, which includes one or more power amplifier drivers and one or more power amplifiers coupled in series and/or in parallel, amplifies the up-converted signal to produce an outbound RF signal 80. The antenna assembly 72, which includes one or more antennas, transmits the outbound RF signal 80. In addition, the antenna assembly 72 receives an inbound RF signal 82 and provides it to the receiver front-end 54.

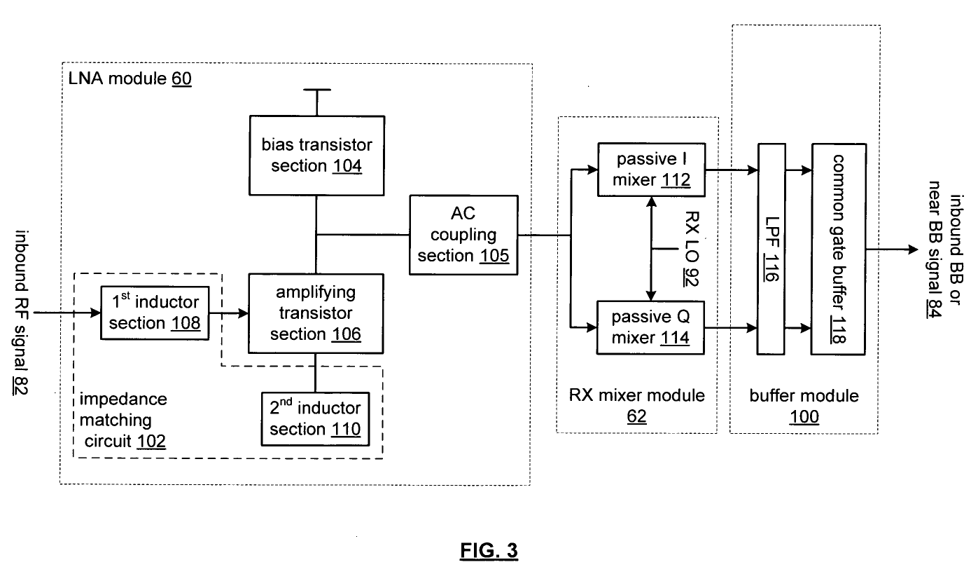

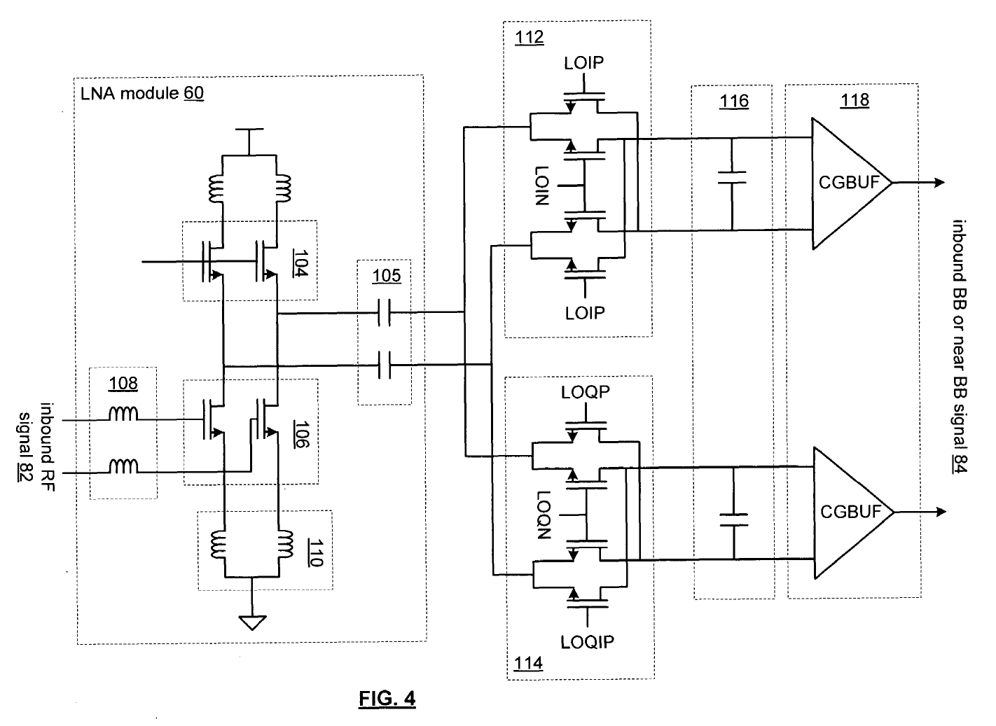

In one embodiment, the receiver front-end 54 includes the low noise amplifier (LNA) module 60 and the receiver mixing module 62. The LNA module 60 (embodiments of which will be described in greater detail with reference to FIGS. 3 and 4) amplifies the inbound RF signal 82 to produce an amplified inbound RF current signal. To facilitate the amplification, the LNA module 60 has a desired impedance for the frequency band of the inbound RF signal 82. For example, the carrier frequency of the inbound RF signal 82 may be in one of a plurality of frequency bands that includes at least two of 800 MHz, 900 MHz, 1800 MHz, 1900 MHz, 2100 MHz, 2400 MHz, and 5 GHz.

The receiver mixer module 62 (embodiments of which will be described in greater detail with reference to FIGS. 3 and 4) is directly coupled to the LNA module 60 to mix the amplified inbound RF current signal with a receiver local oscillation 92 to produce a mixed signal. In an embodiment of the receiver mixer module 62, it mixes in-phase (I) and quadrature (Q) components of the amplified inbound RF signal with in-phase and quadrature components of receiver local oscillation 92 to produce a mixed I signal and a mixed Q signal. The mixed I and Q signals are combined to produce the mixed signal. In this embodiment, the mixed signal includes phase information (e.g., ±Δθ [phase shift] and/or θ(t) [phase modulation]) and/or frequency information (e.g., ±Δf [frequency shift] and/or f(t) [frequency modulation]). In another embodiment and/or in furtherance of the preceding embodiment, the inbound RF signals 82 includes amplitude information (e.g., ±ΔA [amplitude shift] and/or A(t) [amplitude modulation]). To recover the amplitude information, the receiver mixing module 54 further includes an amplitude detector such as an envelope detector, a low pass filter, etc.

The receiver mixer module 62 may provide the mixed signal, as the inbound baseband or near baseband signal 84 (e.g., a carrier frequency of 0 Hz to a few MHz) to the processing module 75. The filter, gain, and/or ADC module 64 amplifies and/or filters the inbound baseband or near baseband signal 84 prior to converting it into a digital signal, which corresponds to an inbound symbol stream 86. In another embodiment, the receiver mixer module 62 further includes a buffer module that provides the baseband or near baseband inbound signal 84 as a voltage signal to the processing module 75.

The baseband processing module converts the inbound symbol stream 86 into inbound data 88, which may be voice, audio, text, video, images, graphics, etc. This may be done in accordance with one or more wireless communication protocol such as RFID, IEEE 802.11, Bluetooth, AMPS, digital AMPS, GSM, CDMA, wide bandwidth CDMA (WCMDA), LMDS, MMDS, high-speed downlink packet access (HSDPA), high-speed uplink packet access (HSUPA), Enhanced Data rates for GSM Evolution (EDGE), General Packet Radio Service (GPRS), and/or variations thereof

FIG. 3 is a schematic block diagram of an embodiment of the receiver front-end 54 that includes the LNA module 60, the RX mixer module 62, and the buffer module 100. The LNA module 60 includes a bias transistor section 104, an amplifying transistor section 106, an AC coupling section 105, and an impedance matching circuit 102. As configured, the amplifying transistor section 106 and the impedance matching circuit 102 receive the inbound RF signal 82. The amplifying transistor section 106 amplifies the inbound RF signal 82 in accordance with biasing provided by the bias transistor section 104 to produce an amplified inbound RF signal. The AC coupling section 105 converts the amplified inbound RF signal into the amplified inbound RF current signal.

An embodiment of the impedance matching circuit may include first and second inductor sections 108 and 110. The first inductor section 102 is coupled to at least one input of the amplifying transistor section 106 and the second inductor section 110 is coupled to at least one output of the amplifying transistor section, wherein capacitance of the amplifying transistor section 110. The inductance of the first and/or second inductor sections 108 and 110 is selected to provide the desired impedance of the LNA module 60.

In an embodiment, the RX mixer module is a current domain mixing module that includes a passive in-phase (I) mixer 112 and a passive quadrature (Q) mixer 114. The passive in-phase mixer 112 mixes an in-phase component of the local oscillation 92 with the amplified inbound RF current signal to produce an in-phase mixed signal. The passive quadrature mixer 114 mixes a quadrature component of the local oscillation 92 with the amplified inbound RF current signal to produce a quadrature mixed signal. In this embodiment, the mixed current signal includes the in-phase and quadrature mixed signals. Note that the DC current of the current domain mixing module is approximately zero.

The buffer module 100 may include a low pass filter (LPF) 116 and a common gate buffer 118. The low pass filter module 116 filters the mixed current signal to produce a filtered signal. The common gate buffer 118 buffers the filtered signal to produce the inbound baseband or near baseband voltage signal 84. The LPF 116 may include shunt capacitors of 200 pf between inputs of the CGBUFs to provide additional high frequency blocker attenuation and/or to improve the linearity. In addition, the shunt capacitors help establish an input impedance of the buffers that remains below 20 up to 250 MHz.

FIG. 4 is a schematic block diagram of another embodiment of a receiver front-end 54 that includes the LNA module 60, the RX mixer module 62, and the buffer module 100. The LNA module 60 includes a bias transistor section 104, an amplifying transistor section 106, an AC coupling section 105, and an impedance matching circuit 102. The RX mixer module is a current domain mixing module that includes a passive in-phase (I) mixer 112 and a passive quadrature (Q) mixer 114. The buffer module 100 may include a low pass filter (LPF) 116 and a common gate buffer 118.

In this embodiment, the LNA module 60 is a high transconductance LNA followed by current driven passive mixers 112 and 114 that drive a low impedance load consisting of the first stage of a common gate buffer 118. This embodiment provides a reduction of the noise of the mixer switching pair, which is generally the dominant contributor to the front end flicker noise, since there is no DC current flowing through the switching devices. Although some extra noise (both flicker and white) may be contributed by the common gate buffer, a significant overall advantage can be obtained using a noise optimized buffer design.

A desired level of linearity is obtained by operating the passive mixers 112 and 114 in the current domain while keeping their load impedance low. Such an embodiment substantially eliminates the distortion associated with having a large voltage swing at the mixer input of active and/or passive mixers operated in the voltage mode. In addition, a desired level of power saving is achieved in a variety of ways. First, the use of two (I and Q) current driven passive mixers 112 and 114 loaded by a low impedance common gate buffer (CGBUF). This insures that the passive mixers 112 and 114 have approximately zero DC current while the extra common gate buffer burns a limited power since it is processing baseband signals. Further power saving is obtained by using a first order active filter(s) as the common gate buffer(s). Second, as the low noise amplifier drives the current mode mixer directly, the need of a Gm stage is eliminated, which saves power and improves linearity. Third, a 1.2-V supply may be used to supply the RFIC section 58 and the processing module 75.

The LNA module 60 has very low noise and provides sufficient gain (transconductance) to reduce the input referred noise contribution of the following stages. In addition, the LNA module 60 may be a differential LNA and have a synthesized input impedance of 50 Ohms. This is achieved by including the impedance matching circuit 102 to provide on-chip inductive degeneration such that the LNA acts as a transconductor with an equivalent gain of 90˜100 mS. In one embodiment, the second inductor section 110 may include on-chip spiral inductors, which may also be used to couple the biasing transistors 104 to the power supply, and bond-wire inductors are used for the first inductor section 108.

To avoid low frequency noise leakage, to improve IIP2, and to reduce the equivalent input noise, the LNA is loaded with a properly sized inductor and it is AC coupled 105 to the mixers 112 and 114. The mixers 112 and 114, which may be double balanced passive mixers, perform the down conversion by mixing the current signal provided by the LNA module 60 with I and Q components of the local oscillation 92, which are AC coupled to the mixers 112 and 114 to optimize the DC bias of the switching transistor pairs of the mixers for noise and linearity. In addition, the static overdrive voltage of the mixer's transistors may be chosen to be close to zero to reduce the switching quad flicker noise contribution while providing the desired linearity. Further, the size of the transistors may be numerical optimized by taking into account the tradeoff between linearity and matching on the one hand and noise and driving requirements on the other. For instance, by increasing the transistors size matching and linearity is improved, but may increase driving requirements and noise since it produces a bigger parasitic capacitance.

To further help achieve the high linearity and to reduce LO radiation, the mixers 112 and 114 should have a very low impedance load to reduce the voltage swing at the source and drain of the switching transistors both for the RF and the LO signal. This reduces the amount of LO in the signal path and the distortion associated with the nonlinear capacitors present at internal nodes. Note, however, that the conversion gain is given by the product of the LNA transconductance and the load resistance. Thus, there is a tradeoff between linearity and gain since the linearity improves with a low impedance load while the gain is directly proportional to the load itself. Loading the mixers 112 and 114 with the low impedance nodes of a differential common gate buffer achieves both these contrasting objectives.

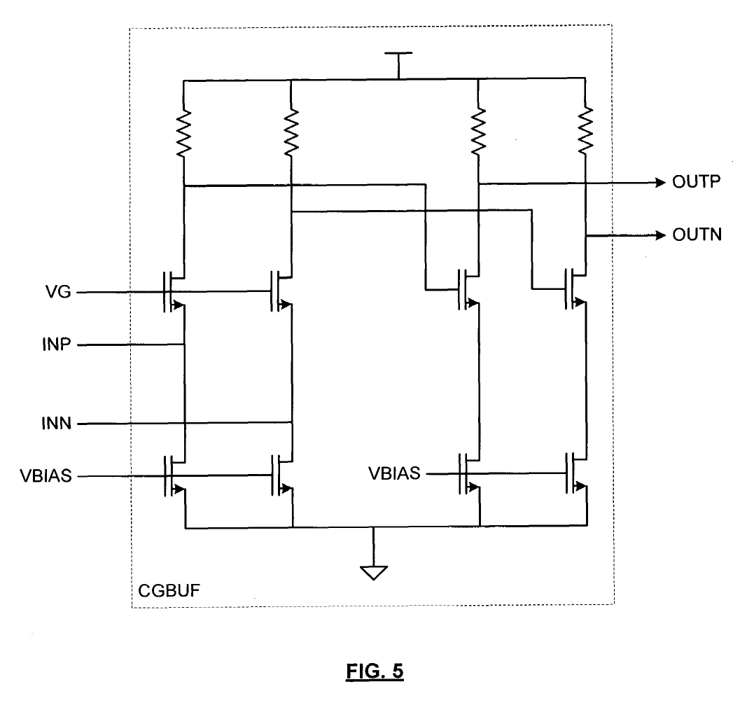

FIG. 5 is a schematic block diagram of an embodiment of a common gate buffer (CGBUF) of the common gate buffer section 118. In this embodiment, the buffer (CGBUF) includes a common gate stage plus a current mode logic buffer. The buffer's bandwidth is large enough to include the channel band (e.g., 5 MHz for direct conversion). This allows the LNA and mixers to provide the current signal without attenuation to the load resistor of the CGBUF.

To minimize the input referred noise of the buffers, the load inductors of the LNA are sized to resonate with the parasitic capacitances of the LNA at RF. This increases the equivalent resistance seen by the buffer thus reducing the noise amplification factor and, hence, reduces the input referred noise. In an embodiment of the buffer, it has a consumption of 2 mA and an equivalent input white noise of 1.5 nV/Hz.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A radio frequency (RF) receiver front-end comprises:
a low noise amplifier (LNA) module coupled to amplify an inbound RF signal to produce an amplified inbound RF current signal;
a current domain mixing module coupled to mix the amplified inbound RF current signal with a local oscillation to produce a mixed current signal; and
a buffer module coupled to provide a baseband or near baseband voltage signal from the mixed current signal.

2. The RF receiver front-end of claim 1, wherein the LNA module comprises:
an impedance matching circuit;
a bias transistor section;
an amplifying transistor section coupled to the impedance matching circuit and to the bias transistor section, wherein the amplifying transistor section and the impedance matching circuit receive the inbound RF signal and wherein the amplifying transistor section amplifies the inbound RF signal in accordance with biasing of the bias transistor section to produce an amplified inbound RF signal; and
an AC coupling section coupled to convert the amplified inbound RF signal into the amplified inbound RF current signal.

3. The RF receiver front-end of claim 2, wherein the impedance matching circuit comprises:
a first inductor section coupled to at least one input of the amplifying transistor section; and
a second inductor section coupled to at least one output of the amplifying transistor section, wherein capacitance of the amplifying transistor section and inductance of at least one of the first and second inductor sections substantially provide the desired impedance.

4. The RF receiver front-end of claim 1, wherein the current domain mixing module comprises:
a passive in-phase mixer coupled to mix an in-phase component of the local oscillation with the amplified inbound RF current signal to produce an in-phase mixed signal; and
a passive quadrature mixer coupled to mix a quadrature component of the local oscillation with the amplified inbound RF current signal to produce a quadrature mixed signal, wherein the mixed current signal includes the in-phase and quadrature mixed signals, and wherein DC current of the current domain mixing module is approximately zero.

5. The RF receiver front-end of claim 1, wherein the buffer module comprises:
a low pass filter module coupled to filter the mixed current signal to produce a filtered signal; and
a common gate buffer coupled to buffer the filtered signal to produce the baseband or near baseband voltage signal.

6. The RF receiver front-end of claim 1 further comprises:
a silicon substrate supporting the LNA module, the current domain mixing module, and the buffer module.

7. The RF receiver front-end of claim 1, wherein the inbound RF signal comprises:
a carrier frequency in one of a plurality of frequency bands, wherein the plurality of frequency band includes at least two of 800 MHz, 900 MHz, 1800 MHz, 1900 MHz, 2100 MHz, 2400 MHz, and 5 GHz.

8. A radio frequency (RF) receiver front-end comprises:
a low noise amplifier (LNA) module coupled to amplify an inbound RF signal to produce an amplified inbound RF current signal, wherein the LNA module has a desired impedance within a frequency band, and wherein a carrier frequency of the inbound RF signal is within the frequency band; and
a mixer module directly coupled to the LNA module, wherein the mixer module mixes the amplified inbound RF current signal with a local oscillation to produce a mixed signal.

9. The RF receiver front-end of claim 8, wherein the LNA module comprises:
an impedance matching circuit;
a bias transistor section;
an amplifying transistor section coupled to the impedance matching circuit and to the bias transistor section, wherein the amplifying transistor section and the impedance matching circuit receive the inbound RF signal and wherein the amplifying transistor section amplifies the inbound RF signal in accordance with biasing of the bias transistor section to produce an amplified inbound RF signal; and
an AC coupling section coupled to convert the amplified inbound RF signal into the amplified inbound RF current signal.

10. The RF receiver front-end of claim 9, wherein the impedance matching circuit comprises:
a first inductor section coupled to at least one input of the amplifying transistor section; and
a second inductor section coupled to at least one output of the amplifying transistor section, wherein capacitance of the amplifying transistor section and inductance of at least one of the first and second inductor sections substantially provide the desired impedance.

11. The RF receiver front-end of claim 8, wherein the mixing module comprises:
a passive in-phase mixer coupled to mix an in-phase component of the local oscillation with the amplified inbound RF current signal to produce an in-phase mixed signal; and
a passive quadrature mixer coupled to mix a quadrature component of the local oscillation with the amplified inbound RF current signal to produce a quadrature mixed signal, wherein the mixed current signal includes the in-phase and quadrature mixed signals, and wherein DC current of the current domain mixing module is approximately zero.

12. The RF receiver front-end of claim 8 further comprises:
a silicon substrate supporting the LNA module and the mixing module.

13. The RF receiver front-end of claim 8, wherein the inbound RF signal comprises:
the frequency band is one of a plurality of frequency bands, wherein the plurality of frequency band includes at least two of 800 MHz, 900 MHz, 1800 MHz, 1900 MHz, 2100 MHz, 2400 MHz, and 5 GHz.

14. A radio frequency integrated circuit (RFIC) comprises:
a receiver front-end that includes:
a low noise amplifier (LNA) module coupled to amplify an inbound RF signal to produce an amplified inbound RF current signal, wherein the LNA module has a desired impedance within a frequency band, and wherein a carrier frequency of the inbound RF signal is within the frequency band; and
a mixer module directly coupled to the LNA module, wherein the mixer module mixes the amplified inbound RF current signal with a local oscillation to produce a mixed signal; and
a transmitter front-end coupled to:
mix an outbound baseband or near baseband signal with a transmit local oscillation to produce an up-converted signal; and
a power amplifier module coupled to amplify the up-converted signal to produce an outbound RF signal.

15. The RFIC of claim 14, wherein the receiver front-end further comprises:
a buffer module coupled to provide a baseband or near baseband voltage signal from the mixed current signal.

16. The RFID of claim 15 further comprises:
a processing module coupled to:
convert outbound data into the outbound baseband or near baseband signal; and
convert the inbound baseband or near baseband signal into inbound data.

17. The RFIC of claim 15, wherein the LNA module comprises:
an impedance matching circuit;
a bias transistor section;
an amplifying transistor section coupled to the impedance matching circuit and to the bias transistor section, wherein the amplifying transistor section and the impedance matching circuit receive the inbound RF signal and wherein the amplifying transistor section amplifies the inbound RF signal in accordance with biasing of the bias transistor section to produce an amplified inbound RF signal; and
an AC coupling section coupled to convert the amplified inbound RF signal into the amplified inbound RF current signal.

18. The RFIC of claim 17, wherein the impedance matching circuit comprises:
a first inductor section coupled to at least one input of the amplifying transistor section; and
a second inductor section coupled to at least one output of the amplifying transistor section, wherein capacitance of the amplifying transistor section and inductance of at least one of the first and second inductor sections substantially provide the desired impedance.

19. The RFIC of claim 15, wherein the current domain mixing module comprises:
a passive in-phase mixer coupled to mix an in-phase component of the local oscillation with the amplified inbound RF current signal to produce an in-phase mixed signal; and
a passive quadrature mixer coupled to mix a quadrature component of the local oscillation with the amplified inbound RF current signal to produce a quadrature mixed signal, wherein the mixed current signal includes the in-phase and quadrature mixed signals, and wherein DC current of the current domain mixing module is approximately zero.

20. The RFIC of claim 15, wherein the buffer module comprises:
a low pass filter module coupled to filter the mixed current signal to produce a filtered signal; and
a common gate buffer coupled to buffer the filtered signal to produce the baseband or near baseband voltage signal.

21. The RFIC of claim 14, wherein the inbound RF signal comprises:
a carrier frequency in one of a plurality of frequency bands, wherein the plurality of frequency band includes at least two of 800 MHz, 900 MHz, 1800 MHz, 1900 MHz, 2100 MHz, 2400 MHz, and 5 GHz.
